(19) United States
(12) Patent Application Publication
(10) Pub. No.: US 2023/0260004 A1
(43) Pub. Date: Aug. 17, 2023

(54) SYSTEMS AND METHOD FOR PROVIDING CONTEXTUAL PRODUCT RECOMMENDATIONS

(71) Applicant: SHOPIFY INC., Ottawa (CA)

(72) Inventors: Adeline KUO, Whitestone, NY (US); Bhanu Krishna POTLURI, Ann Arbor, MI (US); Kermit Grady THREATTE, Lincoln, MA (US)

(21) Appl. No.: 17/673,496

(22) Filed: Feb. 16, 2022

(51) Int. Cl. G06Q 30/06; G06Q 30/02; G06Q 10/08

(52) U.S. Cl. CPC G06Q 30/0631; G06Q 30/0282; G06Q 30/0239; G06Q 10/08345; G06Q 10/0838

(57) ABSTRACT

The present disclosure provides a product recommendation system and method for recommending products to add to a current transaction. The method includes, during a transaction process for one or more products: computing a parcel attribute of an expected parcel for shipping the one or more products, the parcel attribute being a weight or a dimension of the expected parcel, and identifying an applicable shipping rate for delivering the expected parcel. The method also includes determining an attribute increase threshold that corresponds to an increase in the shipping rate that is within a shipping rate increase threshold, identifying additional products each having a corresponding attribute that is within the attribute increase threshold, and generating a recommendation for the additional products in real-time during the transaction process. Responsive to receiving selection of one of the recommendations, including the corresponding additional product in the transaction process. The transaction is then completed.

### FIELD

The present disclosure relates to systems and methods for providing product recommendations, and, more particularly, to providing such recommendations at checkout to a customer, and yet more particularly, to systems and methods for providing contextual product recommendations at checkout taking into account shipping costs.

### BACKGROUND

Product recommendation engines are filtering systems that seek to predict and show products to a customer that the customer would like, or is likely, to purchase. Predicting recommendations that a customer is expected to enjoy or purchase helps to provide a better customer experience while also increasing revenue for the merchant.

Conventional product recommendation engines often look at and rely on customer preferences in order to identify which products to recommend to which customer. For example, known factors include a customer's particular browsing and/or purchase history, and other information extracted from larger demographic sales data. Such recommendation engines are generally focused on customer inclinations.

### SUMMARY

In various examples, the present disclosure describes systems and methods to recommend products to add to a customer's current transaction, and more particularly systems and methods that take shipping methods and costs into account when identifying which products to recommend. In particular, the present disclosure enables recommendation of products to add to a customer's transaction, with consideration that a recommended product should be within the additional shipping capacity (as further discussed below) of the existing transaction.

Existing product recommendation engines typically do not take into account how shipping costs would be affected by the inclusion of any of the recommended products. Instead, they effectively assume that a buyer or merchant (depending on the manner in which shipping costs are recovered) would accept any added shipping costs associated with the recommended product. However, product recommendation engines that operate based on this assumption often result in suboptimal recommendations, for example, by recommending a heavy and/or large product (with associated high shipping cost) to add to an otherwise low weight and/or small shipment. This unnecessarily increases shipping costs and may lead to merchants avoiding deploying existing product recommendation engines, and/or buyers avoiding accepting product recommendations. This, in turn, can result in loss of potential additional sales for the merchant and/or reduced value for the customer.

Traditionally, when shopping at brick and mortar stores, a customer can physically interact with the product(s) and assess their size and weight etc. The customer also generally does not require the products to be shipped to their home, as they usually take the products with them. That is not the case in the realm of e-commerce. The inability to accurately assess the total volume and/or weight of a combination of products, and inability to optimize shipping capacity and costs in real time, are computer problems that are unique to e-commerce, as equivalent issues simply do not exist in traditional brick and mortar shopping methods. The present disclosure therefore addresses a unique online, electronic problem that has no non-computerized equivalent, and presents a solution that also uniquely requires an online, electronic implementation that has not non-computerized equivalent. Thus, the present disclosure provides the technical solution of a more intelligent recommendation engine that enables optimization of the available shipping capacity of a current transaction, by generating recommendations for products that can fit within available shipping capacity.

The present disclosure also enables better use of the shipping provider's resources, for example by optimizing the use of physical resources at the carrier, such as packaging, vehicle usage, fuel, personnel, etc. The present disclosure may also provide environmental benefits by promoting more efficient use of shipping capacity.

In some examples, the present disclosure describes a system comprising: at least one processing unit and at least one memory, the at least one memory storing instructions executable by the at least one processor to cause the system to: during a transaction process for one or more products offered at an online store of a merchant: compute a parcel attribute of an expected parcel for shipping the one or more products, the parcel attribute being a weight or a dimension of the expected parcel; identify, based on the parcel attribute, an applicable shipping rate for delivering the expected parcel; determine an attribute increase threshold that corresponds to an increase in the shipping rate that is within a shipping rate increase threshold; identify one or more additional products where each of the one or more additional products has a corresponding attribute that is within the attribute increase threshold; and generate at least one recommendation for at least one of the one or more additional products in real-time during the transaction process; responsive to receiving selection of one of the at least one recommendation, include the corresponding additional product in the transaction process; and complete the transaction process.

In some examples, the present disclosure describes a computer-implemented method comprising: during a transaction process for one or more products offered at an online store of a merchant: computing a parcel attribute of an expected parcel for shipping the one or more products, the parcel attribute being a weight or a dimension of the expected parcel; identifying, based on the parcel attribute, an applicable shipping rate for delivering the expected parcel; determining an attribute increase threshold that corresponds to an increase in the shipping rate that is within a shipping rate increase threshold; identifying one or more additional products where each of the one or more additional products has a corresponding attribute that is within the attribute increase threshold; and generating at least one recommendation for at least one of the one or more additional products in real-time during the transaction process; responsive to receiving selection of one of the at least one recommendation, including the corresponding additional product in the transaction process; and completing the transaction process.

In some examples, the present disclosure describes a computer readable medium having instructions encoded thereon, wherein the instructions, when executed by a computing system, cause the computing system to: during a transaction process for one or more products offered at an online store of a merchant: compute a parcel attribute of an expected parcel for shipping the one or more products, the parcel attribute being a weight or a dimension of the expected parcel; identify, based on the parcel attribute, an applicable shipping rate for delivering the expected parcel; determine an attribute increase threshold that corresponds to an increase in the shipping rate that is within a shipping rate increase threshold; identify one or more additional products where each of the one or more additional products has a corresponding attribute that is within the attribute increase threshold; generate at least one recommendation for at least one of the one or more additional products in real-time during the transaction process; and responsive to receiving selection of one of the at least one recommendation, include the corresponding additional product in the transaction process; and complete the transaction process.

In any of the above examples, after selection of the recommendation, and prior to completing the transaction process: an updated parcel attribute of an updated expected parcel is computed for shipping the one or more products and the additional product; based on the updated parcel attribute, an updated applicable shipping rate for delivering the updated expected parcel is identified; an updated attribute increase threshold that corresponds to an updated increase in the shipping rate that is within an updated shipping rate increase threshold is determined; the one or more additional products is updated by identifying one or more updated additional products each having a corresponding attribute within the updated attribute increase threshold; at least one updated recommendation is generated for at least one of the one or more updated additional products in real time during the transaction process; responsive to receiving selection of one of the at least one updated recommendation, the corresponding updated additional product is included in the transaction process.

In any of the above examples, wherein the one or more additional products comprises multiple additional products, the multiple additional products are ranked and a subset of the ranked additional products is selected, wherein the generating comprises generating the recommendation for each of the ranked additional products in the subset in real-time during the transaction process.

In any of the above examples, the ranking of the additional products comprises sorting the additional products by correlation with the one or more products.

In any of the above examples, the ranking of the additional products comprises sorting the additional products by their staleness.

In any of the above examples, the ranking of the additional products comprises sorting the additional products by an amount of time in which the additional product is considered to be pertinent to the customer.

In any of the above examples, the recommendation for the at least one of the one or more additional products is provided as selectable recommended products, where at least one of the selectable recommended products is provided with an incentive.

In any of the above examples, the incentive is a discount on one or more of the selectable recommended products.

In any of the above examples, the parcel attribute of the expected parcel is computed using historical data of parcel attributes of previously shipped parcels of similar products.

### BRIEF DESCRIPTION OF THE DRAWINGS

Reference will now be made, by way of example, to the accompanying drawings which show example embodiments of the present application, and in which:

FIG. 1 is a block diagram of an example e-commerce platform, in which examples described herein may be implemented;

FIG. 2 is an example homepage of an administrator, which may be accessed via the e-commerce platform of FIG. 1;

FIG. 3 is another block diagram of an example e-commerce platform, including a product recommendation engine, in which examples described herein may be implemented;

FIG. 4 is another block diagram of the e-commerce platform of FIG. 1, showing some details related to product recommendation;

FIG. 5 is a flowchart illustrating an example method for product recommendation, in accordance with examples of the present disclosure; and

FIG. 6 a flowchart illustrating an example method for an extension to the method of FIG. 5, in accordance with examples of the present disclosure, in accordance with examples of the present disclosure.

Similar reference numerals may have been used in different figures to denote similar components.

### DESCRIPTION OF EXAMPLE EMBODIMENTS

Examples of the present disclosure are described in the context of an e-commerce platform. However, it should be understood that the e-commerce platform described herein is only one possible example and is not intended to be limiting. It should be understood that the present disclosure may be implemented in other contexts, and is not necessarily limited to implementation in an e-commerce platform.

Examples of the present disclosure describe functionality of the e-commerce platform 100 to provide contextual product recommendations to a customer during a transaction process, where among other things, the recommendations take shipping rates and methods into account.

An Example e-Commerce Platform

Although integration with a commerce platform is not required, in some embodiments, the methods disclosed herein may be performed on or in association with a commerce platform such as an e-commerce platform. Therefore, an example of a commerce platform will be described.

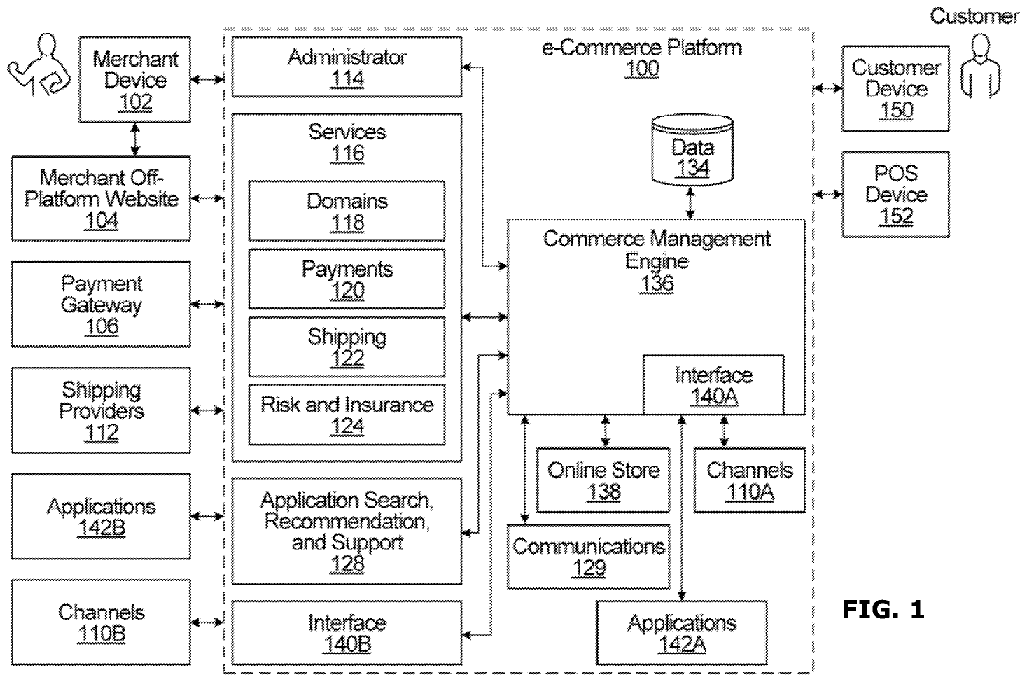

FIG. 1 illustrates an example e-commerce platform 100, according to one embodiment. The e-commerce platform 100 may be used to provide merchant products and services to customers. While the disclosure contemplates using the apparatus, system, and process to purchase products and services, for simplicity the description herein will refer to products. All references to products throughout this disclosure should also be understood to be references to products and/or services, including, for example, physical products, digital content (e.g., music, videos, games), software, tickets, subscriptions, services to be provided, and the like.

While the disclosure throughout contemplates that a ‘merchant’ and a ‘customer’ may be more than individuals, for simplicity the description herein may generally refer to merchants and customers as such. All references to merchants and customers throughout this disclosure should also be understood to be references to groups of individuals, companies, corporations, computing entities, and the like, and may represent for-profit or not-for-profit exchange of products. Further, while the disclosure throughout refers to ‘merchants’ and ‘customers’, and describes their roles as such, the e-commerce platform 100 should be understood to more generally support users in an e-commerce environment, and all references to merchants and customers throughout this disclosure should also be understood to be references to users, such as where a user is a merchant-user (e.g., a seller, retailer, wholesaler, or provider of products), a customer-user (e.g., a buyer, purchase agent, consumer, or user of products), a prospective user (e.g., a user browsing and not yet committed to a purchase, a user evaluating the e-commerce platform 100 for potential use in marketing and selling products, and the like), a service provider user (e.g., a shipping provider 112, a financial provider, and the like), a company or corporate user (e.g., a company representative for purchase, sales, or use of products; an enterprise user; a customer relations or customer management agent, and the like), an information technology user, a computing entity user (e.g., a computing bot for purchase, sales, or use of products), and the like. Furthermore, it may be recognized that while a given user may act in a given role (e.g., as a merchant) and their associated device may be referred to accordingly (e.g., as a merchant device) in one context, that same individual may act in a different role in another context (e.g., as a customer) and that same or another associated device may be referred to accordingly (e.g., as a customer device). For example, an individual may be a merchant for one type of product (e.g., shoes), and a customer/consumer of other types of products (e.g., groceries). In another example, an individual may be both a consumer and a merchant of the same type of product. In a particular example, a merchant that trades in a particular category of goods may act as a customer for that same category of goods when they order from a wholesaler (the wholesaler acting as merchant).

The e-commerce platform 100 provides merchants with online services/facilities to manage their business. The facilities described herein are shown implemented as part of the platform 100 but could also be configured separately from the platform 100, in whole or in part, as stand-alone services. Furthermore, such facilities may, in some embodiments, may, additionally or alternatively, be provided by one or more providers/entities.

In the example of FIG. 1, the facilities are deployed through a machine, service or engine that executes computer software, modules, program codes, and/or instructions on one or more processors which, as noted above, may be part of or external to the platform 100. Merchants may utilize the e-commerce platform 100 for enabling or managing commerce with customers, such as by implementing an e-commerce experience with customers through an online store 138, applications 142A-B, channels 110A-B, and/or through point of sale (POS) devices 152 in physical locations (e.g., a physical storefront or other location such as through a kiosk, terminal, reader, printer, 3D printer, and the like). A merchant may utilize the e-commerce platform 100 as a sole commerce presence with customers, or in conjunction with other merchant commerce facilities, such as through a physical store (e.g., ‘brick-and-mortar’ retail stores), a merchant off-platform website 104 (e.g., a commerce Internet website or other internet or web property or asset supported by or on behalf of the merchant separately from the e-commerce platform 100), an application 142B, and the like. However, even these ‘other’ merchant commerce facilities may be incorporated into or communicate with the e-commerce platform 100, such as where POS devices 152 in a physical store of a merchant are linked into the e-commerce platform 100, where a merchant off-platform website 104 is tied into the e-commerce platform 100, such as, for example, through ‘buy buttons’ that link content from the merchant off platform website 104 to the online store 138, or the like.

The online store 138 may represent a multi-tenant facility comprising a plurality of virtual storefronts. In embodiments, merchants may configure and/or manage one or more storefronts in the online store 138, such as, for example, through a merchant device 102 (e.g., computer, laptop computer, mobile computing device, and the like), and offer products to customers through a number of different channels 110A-B (e.g., an online store 138; an application 142A-B; a physical storefront through a POS device 152; an electronic marketplace, such, for example, through an electronic buy button integrated into a website or social media channel such as on a social network, social media page, social media messaging system; and/or the like). A merchant may sell across channels 110A-B and then manage their sales through the e-commerce platform 100, where channels 110A may be provided as a facility or service internal or external to the e-commerce platform 100. A merchant may, additionally or alternatively, sell in their physical retail store, at pop ups, through wholesale, over the phone, and the like, and then manage their sales through the e-commerce platform 100. A merchant may employ all or any combination of these operational modalities. Notably, it may be that by employing a variety of and/or a particular combination of modalities, a merchant may improve the probability and/or volume of sales. Throughout this disclosure the terms online store 138 and storefront may be used synonymously to refer to a merchant's online e-commerce service offering through the e-commerce platform 100, where an online store 138 may refer either to a collection of storefronts supported by the e-commerce platform 100 (e.g., for one or a plurality of merchants) or to an individual merchant's storefront (e.g., a merchant's online store).

In some embodiments, a customer may interact with the platform 100 through a customer device 150 (e.g., computer, laptop computer, mobile computing device, or the like), a POS device 152 (e.g., retail device, kiosk, automated (self-service) checkout system, or the like), and/or any other commerce interface device known in the art. The e-commerce platform 100 may enable merchants to reach customers through the online store 138, through applications 142A-B, through POS devices 152 in physical locations (e.g., a merchant's storefront or elsewhere), to communicate with customers via electronic communication facility 129, and/or the like so as to provide a system for reaching customers and facilitating merchant services for the real or virtual pathways available for reaching and interacting with customers.

In some embodiments, and as described further herein, the e-commerce platform 100 may be implemented through a processing facility. Such a processing facility may include a processor and a memory. The processor may be a hardware processor. The memory may be and/or may include a non-transitory computer-readable medium. The memory may be and/or may include random access memory (RAM) and/or persisted storage (e.g., magnetic storage). The processing facility may store a set of instructions (e.g., in the memory) that, when executed, cause the e-commerce platform 100 to perform the e-commerce and support functions as described herein. The processing facility may be or may be a part of one or more of a server, client, network infrastructure, mobile computing platform, cloud computing platform, stationary computing platform, and/or some other computing platform, and may provide electronic connectivity and communications between and amongst the components of the e-commerce platform 100, merchant devices 102, payment gateways 106, applications 142A-B, channels 110A-B, shipping providers 112, customer devices 150, point of sale devices 152, etc. In some implementations, the processing facility may be or may include one or more such computing devices acting in concert. For example, it may be that a plurality of co-operating computing devices serves as/to provide the processing facility. The e-commerce platform 100 may be implemented as or using one or more of a cloud computing service, software as a service (SaaS), infrastructure as a service (IaaS), platform as a service (PaaS), desktop as a service (DaaS), managed software as a service (MSaaS), mobile backend as a service (MBaaS), information technology management as a service (ITMaaS), and/or the like. For example, it may be that the underlying software implementing the facilities described herein (e.g., the online store 138) is provided as a service, and is centrally hosted (e.g., and then accessed by users via a web browser or other application, and/or through customer devices 150, POS devices 152, and/or the like). In some embodiments, elements of the e-commerce platform 100 may be implemented to operate and/or integrate with various other platforms and operating systems.

In some embodiments, the facilities of the e-commerce platform 100 (e.g., the online store 138) may serve content to a customer device 150 (using data 134) such as, for example, through a network connected to the e-commerce platform 100. For example, the online store 138 may serve or send content in response to requests for data 134 from the customer device 150, where a browser (or other application) connects to the online store 138 through a network using a network communication protocol (e.g., an internet protocol). The content may be written in machine readable language and may include Hypertext Markup Language (HTML), template language, JavaScript, and the like, and/or any combination thereof.

In some embodiments, online store 138 may be or may include service instances that serve content to customer devices and allow customers to browse and purchase the various products available (e.g., add them to a cart, purchase through a buy-button, and the like). Merchants may also customize the look and feel of their website through a theme system, such as, for example, a theme system where merchants can select and change the look and feel of their online store 138 by changing their theme while having the same underlying product and business data shown within the online store's product information. It may be that themes can be further customized through a theme editor, a design interface that enables users to customize their website's design with flexibility. Additionally or alternatively, it may be that themes can, additionally or alternatively, be customized using theme-specific settings such as, for example, settings as may change aspects of a given theme, such as, for example, specific colors, fonts, and pre-built layout schemes. In some implementations, the online store may implement a content management system for website content. Merchants may employ such a content management system in authoring blog posts or static pages and publish them to their online store 138, such as through blogs, articles, landing pages, and the like, as well as configure navigation menus. Merchants may upload images (e.g., for products), video, content, data, and the like to the e-commerce platform 100, such as for storage by the system (e.g., as data 134). In some embodiments, the e-commerce platform 100 may provide functions for manipulating such images and content such as, for example, functions for resizing images, associating an image with a product, adding and associating text with an image, adding an image for a new product variant, protecting images, and the like.

As described herein, the e-commerce platform 100 may provide merchants with sales and marketing services for products through a number of different channels 110A-B, including, for example, the online store 138, applications 142A-B, as well as through physical POS devices 152 as described herein. The e-commerce platform 100 may, additionally or alternatively, include business support services 116, an administrator 114, a warehouse management system, and the like associated with running an on-line business, such as, for example, one or more of providing a domain registration service 118 associated with their online store, payment services 120 for facilitating transactions with a customer, shipping services 122 for providing customer shipping options for purchased products, fulfillment services for managing inventory, risk and insurance services 124 associated with product protection and liability, merchant billing, and the like. Services 116 may be provided via the e-commerce platform 100 or in association with external facilities, such as through a payment gateway 106 for payment processing, shipping providers 112 for expediting the shipment of products, and the like.

In some embodiments, the e-commerce platform 100 may be configured with shipping services 122 (e.g., through an e-commerce platform shipping facility or through a third-party shipping carrier), to provide various shipping-related information to merchants and/or their customers such as, for example, shipping label or rate information, real-time delivery updates, tracking, and/or the like.

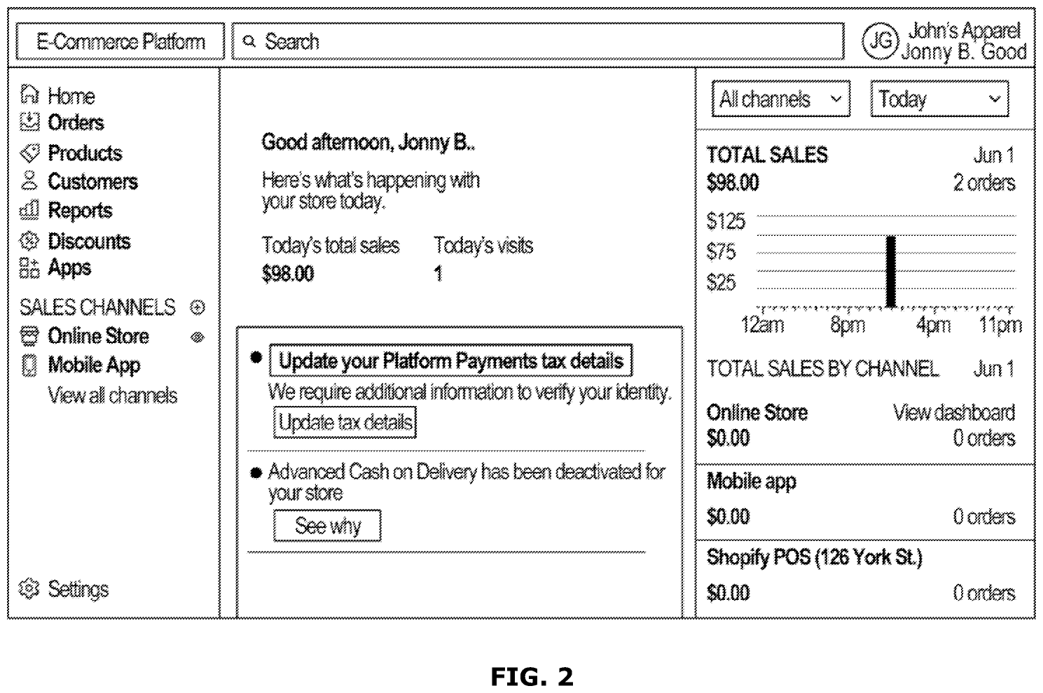

FIG. 2 depicts a non-limiting embodiment for a home page of an administrator 114. The administrator 114 may be referred to as an administrative console and/or an administrator console. The administrator 114 may show information about daily tasks, a store's recent activity, and the next steps a merchant can take to build their business. In some embodiments, a merchant may log in to the administrator 114 via a merchant device 102 (e.g., a desktop computer or mobile device), and manage aspects of their online store 138, such as, for example, viewing the online store's 138 recent visit or order activity, updating the online store's 138 catalog, managing orders, and/or the like. In some embodiments, the merchant may be able to access the different sections of the administrator 114 by using a sidebar, such as the one shown on FIG. 2. Sections of the administrator 114 may include various interfaces for accessing and managing core aspects of a merchant's business, including orders, products, customers, available reports and discounts. The administrator 114 may, additionally or alternatively, include interfaces for managing sales channels for a store including the online store 138, mobile application(s) made available to customers for accessing the store (Mobile App), POS devices, and/or a buy button. The administrator 114 may, additionally or alternatively, include interfaces for managing applications (apps) installed on the merchant's account; and settings applied to a merchant's online store 138 and account. A merchant may use a search bar to find products, pages, or other information in their store.

More detailed information about commerce and visitors to a merchant's online store 138 may be viewed through reports or metrics. Reports may include, for example, acquisition reports, behavior reports, customer reports, finance reports, marketing reports, sales reports, product reports, and custom reports. The merchant may be able to view sales data for different channels 110A-B from different periods of time (e.g., days, weeks, months, and the like), such as by using drop-down menus. An overview dashboard may also be provided for a merchant who wants a more detailed view of the store's sales and engagement data. An activity feed in the home metrics section may be provided to illustrate an overview of the activity on the merchant's account. For example, by clicking on a ‘view all recent activity’ dashboard button, the merchant may be able to see a longer feed of recent activity on their account. A home page may show notifications about the merchant's online store 138, such as based on account status, growth, recent customer activity, order updates, and the like. Notifications may be provided to assist a merchant with navigating through workflows configured for the online store 138, such as, for example, a payment workflow, an order fulfillment workflow, an order archiving workflow, a return workflow, and the like.

The e-commerce platform 100 may provide for a communications facility 129 and associated merchant interface for providing electronic communications and marketing, such as utilizing an electronic messaging facility for collecting and analyzing communication interactions between merchants, customers, merchant devices 102, customer devices 150, POS devices 152, and the like, to aggregate and analyze the communications, such as for increasing sale conversions, and the like. For instance, a customer may have a question related to a product, which may produce a dialog between the customer and the merchant (or an automated processor-based agent/chatbot representing the merchant), where the communications facility 129 is configured to provide automated responses to customer requests and/or provide recommendations to the merchant on how to respond such as, for example, to improve the probability of a sale.

The e-commerce platform 100 may provide a financial facility 120 for secure financial transactions with customers, such as through a secure card server environment. The e-commerce platform 100 may store credit card information, such as in payment card industry data (PCI) environments (e.g., a card server), to reconcile financials, bill merchants, perform automated clearing house (ACH) transfers between the e-commerce platform 100 and a merchant's bank account, and the like. The financial facility 120 may also provide merchants and buyers with financial support, such as through the lending of capital (e.g., lending funds, cash advances, and the like) and provision of insurance. In some embodiments, online store 138 may support a number of independently administered storefronts and process a large volume of transactional data on a daily basis for a variety of products and services. Transactional data may include any customer information indicative of a customer, a customer account or transactions carried out by a customer such as, for example, contact information, billing information, shipping information, returns/refund information, discount/offer information, payment information, or online store events or information such as page views, product search information (search keywords, click-through events), product reviews, abandoned carts, and/or other transactional information associated with business through the e-commerce platform 100. In some embodiments, the e-commerce platform 100 may store this data in a data facility 134. Referring again to FIG. 1, in some embodiments the e-commerce platform 100 may include a commerce management engine 136 such as may be configured to perform various workflows for task automation or content management related to products, inventory, customers, orders, suppliers, reports, financials, risk and fraud, and the like. In some embodiments, additional functionality may, additionally or alternatively, be provided through applications 142A-B to enable greater flexibility and customization required for accommodating an ever-growing variety of online stores, POS devices, products, and/or services. Applications 142A may be components of the e-commerce platform 100 whereas applications 142B may be provided or hosted as a third-party service external to e-commerce platform 100. The commerce management engine 136 may accommodate store-specific workflows and in some embodiments, may incorporate the administrator 114 and/or the online store 138.

Implementing functions as applications 142A-B may enable the commerce management engine 136 to remain responsive and reduce or avoid service degradation or more serious infrastructure failures, and the like.

Although isolating online store data can be important to maintaining data privacy between online stores 138 and merchants, there may be reasons for collecting and using cross-store data, such as, for example, with an order risk assessment system or a platform payment facility, both of which require information from multiple online stores 138 to perform well. In some embodiments, it may be preferable to move these components out of the commerce management engine 136 and into their own infrastructure within the e-commerce platform 100.

Platform payment facility 120 is an example of a component that utilizes data from the commerce management engine 136 but is implemented as a separate component or service. The platform payment facility 120 may allow customers interacting with online stores 138 to have their payment information stored safely by the commerce management engine 136 such that they only have to enter it once. When a customer visits a different online store 138, even if they have never been there before, the platform payment facility 120 may recall their information to enable a more rapid and/or potentially less-error prone (e.g., through avoidance of possible mis-keying of their information if they needed to instead re-enter it) checkout. This may provide a cross-platform network effect, where the e-commerce platform 100 becomes more useful to its merchants and buyers as more merchants and buyers join, such as because there are more customers who checkout more often because of the ease of use with respect to customer purchases. To maximize the effect of this network, payment information for a given customer may be retrievable and made available globally across multiple online stores 138.

For functions that are not included within the commerce management engine 136, applications 142A-B provide a way to add features to the e-commerce platform 100 or individual online stores 138. For example, applications 142A-B may be able to access and modify data on a merchant's online store 138, perform tasks through the administrator 114, implement new flows for a merchant through a user interface (e.g., that is surfaced through extensions/API), and the like. Merchants may be enabled to discover and install applications 142A-B through application search, recommendations, and support 128. In some embodiments, the commerce management engine 136, applications 142A-B, and the administrator 114 may be developed to work together. For instance, application extension points may be built inside the commerce management engine 136, accessed by applications 142A and 142B through the interfaces 140B and 140A to deliver additional functionality, and surfaced to the merchant in the user interface of the administrator 114.

In some embodiments, applications 142A-B may deliver functionality to a merchant through the interface 140A-B, such as where an application 142A-B is able to surface transaction data to a merchant (e.g., App: “Engine, surface my app data in the Mobile App or administrator 114”), and/or where the commerce management engine 136 is able to ask the application to perform work on demand (Engine: “App, give me a local tax calculation for this checkout”).

Applications 142A-B may be connected to the commerce management engine 136 through an interface 140A-B (e.g., through REST (REpresentational State Transfer) and/or GraphQL APIs) to expose the functionality and/or data available through and within the commerce management engine 136 to the functionality of applications. For instance, the e-commerce platform 100 may provide API interfaces 140A-B to applications 142A-B which may connect to products and services external to the platform 100. The flexibility offered through use of applications and APIs (e.g., as offered for application development) enable the e-commerce platform 100 to better accommodate new and unique needs of merchants or to address specific use cases without requiring constant change to the commerce management engine 136. For instance, shipping services 122 may be integrated with the commerce management engine 136 through a shipping or carrier service API, thus enabling the e-commerce platform 100 to provide shipping service functionality without directly impacting code running in the commerce management engine 136.

Depending on the implementation, applications 142A-B may utilize APIs to pull data on demand (e.g., customer creation events, product change events, or order cancelation events, etc.) or have the data pushed when updates occur. A subscription model may be used to provide applications 142A-B with events as they occur or to provide updates with respect to a changed state of the commerce management engine 136. In some embodiments, when a change related to an update event subscription occurs, the commerce management engine 136 may post a request, such as to a predefined callback URL. The body of this request may contain a new state of the object and a description of the action or event. Update event subscriptions may be created manually, in the administrator facility 114, or automatically (e.g., via the API 140A-B). In some embodiments, update events may be queued and processed asynchronously from a state change that triggered them, which may produce an update event notification that is not distributed in real-time or near-real time.

In some embodiments, the e-commerce platform 100 may provide one or more of application search, recommendation and support 128. Application search, recommendation and support 128 may include developer products and tools to aid in the development of applications, an application dashboard (e.g., to provide developers with a development interface, to administrators for management of applications, to merchants for customization of applications, and the like), facilities for installing and providing permissions with respect to providing access to an application 142A-B (e.g., for public access, such as where criteria must be met before being installed, or for private use by a merchant), application searching to make it easy for a merchant to search for applications 142A-B that satisfy a need for their online store 138, application recommendations to provide merchants with suggestions on how they can improve the user experience through their online store 138, and the like. In some embodiments, applications 142A-B may be assigned an application identifier (ID), such as for linking to an application (e.g., through an API), searching for an application, making application recommendations, and the like.

Applications 142A-B may be grouped roughly into three categories: customer-facing applications, merchant-facing applications, integration applications, and the like. Customer-facing applications 142A-B may include an online store 138 or channels 110A-B that are places where merchants can list products and have them purchased (e.g., the online store, applications for flash sales (e.g., merchant products or from opportunistic sales opportunities from third-party sources), a mobile store application, a social media channel, an application for providing wholesale purchasing, and the like). Merchant-facing applications 142A-B may include applications that allow the merchant to administer their online store 138 (e.g., through applications related to the web or website or to mobile devices), run their business (e.g., through applications related to POS devices), to grow their business (e.g., through applications related to shipping (e.g., drop shipping), use of automated agents, use of process flow development and improvements), and the like. Integration applications may include applications that provide useful integrations that participate in the running of a business, such as shipping providers 112 and payment gateways 106.

As such, the e-commerce platform 100 can be configured to provide an online shopping experience through a flexible system architecture that enables merchants to connect with customers in a flexible and transparent manner. A typical customer experience may be better understood through an embodiment example purchase workflow, where the customer browses the merchant's products on a channel 110A-B, adds what they intend to buy to their cart, proceeds to checkout, and pays for the content of their cart resulting in the creation of an order for the merchant. The merchant may then review and fulfill (or cancel) the order. The product is then delivered to the customer. If the customer is not satisfied, they might return the products to the merchant.

In an example embodiment, a customer may browse a merchant's products through a number of different channels 110A-B such as, for example, the merchant's online store 138, a physical storefront through a POS device 152; an electronic marketplace, through an electronic buy button integrated into a website or a social media channel). In some cases, channels 110A-B may be modeled as applications 142A-B. A merchandising component in the commerce management engine 136 may be configured for creating, and managing product listings (using product data objects or models for example) to allow merchants to describe what they want to sell and where they sell it. The association between a product listing and a channel may be modeled as a product publication and accessed by channel applications, such as via a product listing API. A product may have many attributes and/or characteristics, like size and color, and many variants that expand the available options into specific combinations of all the attributes, like a variant that is size extra-small and green, or a variant that is size large and blue. Products may have at least one variant (e.g., a “default variant”) created for a product without any options. To facilitate browsing and management, products may be grouped into collections, provided product identifiers (e.g., stock keeping unit (SKU)) and the like. Collections of products may be built by either manually categorizing products into one (e.g., a custom collection), by building rulesets for automatic classification (e.g., a smart collection), and the like. Product listings may include 2D images, 3D images or models, which may be viewed through a virtual or augmented reality interface, and the like.

In some embodiments, a shopping cart object is used to store or keep track of the products that the customer intends to buy. The shopping cart object may be channel specific and can be composed of multiple cart line items, where each cart line item tracks the quantity for a particular product variant. Since adding a product to a cart does not imply any commitment from the customer or the merchant, and the expected lifespan of a cart may be in the order of minutes (not days), cart objects/data representing a cart may be persisted to an ephemeral data store.

The customer then proceeds to checkout. A checkout object or page generated by the commerce management engine 136 may be configured to receive customer information to complete the order such as the customer's contact information, billing information and/or shipping details. If the customer inputs their contact information but does not proceed to payment, the e-commerce platform 100 may (e.g., via an abandoned checkout component) transmit a message to the customer device 150 to encourage the customer to complete the checkout. For those reasons, checkout objects can have much longer lifespans than cart objects (hours or even days) and may therefore be persisted. Customers then pay for the content of their cart resulting in the creation of an order for the merchant. In some embodiments, the commerce management engine 136 may be configured to communicate with various payment gateways and services 106 (e.g., online payment systems, mobile payment systems, digital wallets, credit card gateways) via a payment processing component. The actual interactions with the payment gateways 106 may be provided through a card server environment. At the end of the checkout process, an order is created. An order is a contract of sale between the merchant and the customer where the merchant agrees to provide the goods and services listed on the order (e.g., order line items, shipping line items, and the like) and the customer agrees to provide payment (including taxes). Once an order is created, an order confirmation notification may be sent to the customer and an order placed notification sent to the merchant via a notification component. Inventory may be reserved when a payment processing job starts to avoid over-selling (e.g., merchants may control this behavior using an inventory policy or configuration for each variant). Inventory reservation may have a short time span (minutes) and may need to be fast and scalable to support flash sales or “drops”, which are events during which a discount, promotion or limited inventory of a product may be offered for sale for buyers in a particular location and/or for a particular (usually short) time. The reservation is released if the payment fails. When the payment succeeds, and an order is created, the reservation is converted into a permanent (long-term) inventory commitment allocated to a specific location. An inventory component of the commerce management engine 136 may record where variants are stocked, and may track quantities for variants that have inventory tracking enabled. It may decouple product variants (a customer-facing concept representing the template of a product listing) from inventory items (a merchant-facing concept that represents an item whose quantity and location is managed). An inventory level component may keep track of quantities that are available for sale, committed to an order or incoming from an inventory transfer component (e.g., from a vendor).

The merchant may then review and fulfill (or cancel) the order. A review component of the commerce management engine 136 may implement a business process merchant's use to ensure orders are suitable for fulfillment before actually fulfilling them. Orders may be fraudulent, require verification (e.g., ID checking), have a payment method which requires the merchant to wait to make sure they will receive their funds, and the like. Risks and recommendations may be persisted in an order risk model. Order risks may be generated from a fraud detection tool, submitted by a third-party through an order risk API, and the like. Before proceeding to fulfillment, the merchant may need to capture the payment information (e.g., credit card information) or wait to receive it (e.g., via a bank transfer, check, and the like) before it marks the order as paid. The merchant may now prepare the products for delivery. In some embodiments, this business process may be implemented by a fulfillment component of the commerce management engine 136. The fulfillment component may group the line items of the order into a logical fulfillment unit of work based on an inventory location and fulfillment service. The merchant may review, adjust the unit of work, and trigger the relevant fulfillment services, such as through a manual fulfillment service (e.g., at merchant managed locations) used when the merchant picks and packs the products in a box, purchase a shipping label and input its tracking number, or just mark the item as fulfilled. Alternatively, an API fulfillment service may trigger a third-party application or service to create a fulfillment record for a third-party fulfillment service. Other possibilities exist for fulfilling an order. If the customer is not satisfied, they may be able to return the product(s) to the merchant. The business process merchants may go through to “un-sell” an item may be implemented by a return component. Returns may consist of a variety of different actions, such as a restock, where the product that was sold actually comes back into the business and is sellable again; a refund, where the money that was collected from the customer is partially or fully returned; an accounting adjustment noting how much money was refunded (e.g., including if there was any restocking fees or goods that weren't returned and remain in the customer's hands); and the like. A return may represent a change to the contract of sale (e.g., the order), and where the e-commerce platform 100 may make the merchant aware of compliance issues with respect to legal obligations (e.g., with respect to taxes). In some embodiments, the e-commerce platform 100 may enable merchants to keep track of changes to the contract of sales over time, such as implemented through a sales model component (e.g., an append-only date-based ledger that records sale-related events that happened to an item).

Implementation in an e-Commerce Platform

The functionality described herein may be used in commerce to provide improved customer or buyer experiences. The e-commerce platform 100 could implement the functionality for any of a variety of different applications, examples of which are described elsewhere herein. In particular, examples of the present disclosure describe functionality of the e-commerce platform 100 to provide contextual product recommendations to a customer during a transaction process, where among other things, the recommendations take shipping rates into account. The e-commerce platform 100 may generate the recommendations using a product recommendation engine 350.

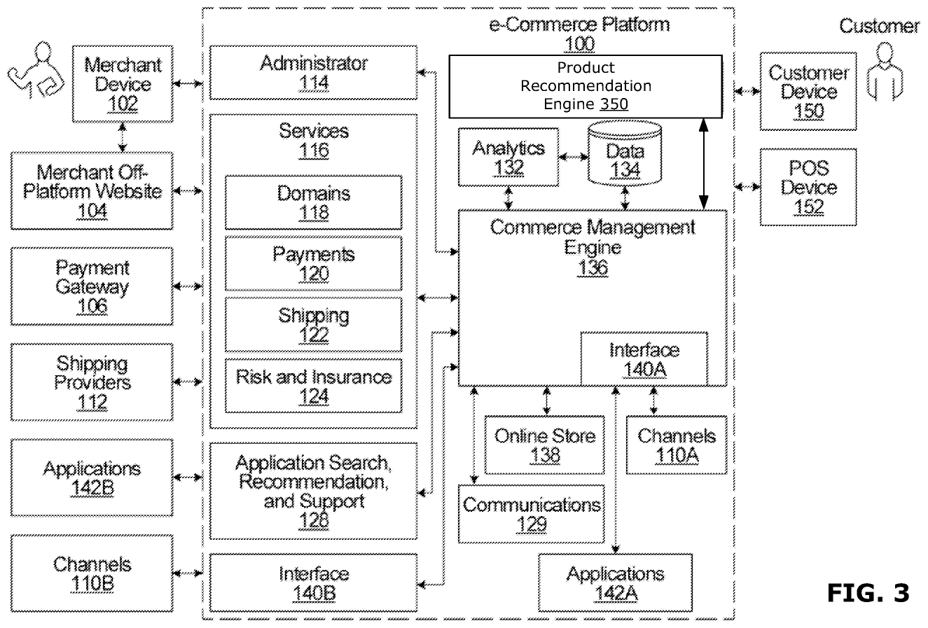

FIG. 3 illustrates the e-commerce platform 100 of FIG. 1 but including analytics 132, and the product recommendation engine 350. Details of the product recommendation engine 350 are discussed further below.

Although the product recommendation engine 350 is illustrated as distinct components of the e-commerce platform 100 in FIG. 3, this is only an example. The product recommendation engine 350 could also or instead be provided by another component residing within or external to the e-commerce platform 100. In some embodiments, either or both of the applications 142A-B may provide an embodiment of the product recommendation engine 350 that implement the functionality described herein. The location of the product recommendation engine 350 may be implementation specific.

In some implementations, the product recommendation engine 350 may be provided at least in part by the e-commerce platform 100, either as a core function of the e-commerce platform 100 or as one or more applications or services supported by or communicating with the e-commerce platform 100. For simplicity, the present disclosure describes the operation of the product recommendation engine 350 when the product recommendation engine 350 is implemented in the e-commerce platform 100, however this is not intended to be limiting. For example, at least some functions of the product recommendation engine 350 may by additionally or alternatively be implemented on the customer device 150.

In some implementations, the examples disclosed herein may be implemented using a different platform that is not necessarily (or is not limited to) the e-commerce platform 100. In general, examples of the present disclosure are not intended to be limited to implementation on the e-commerce platform 100.

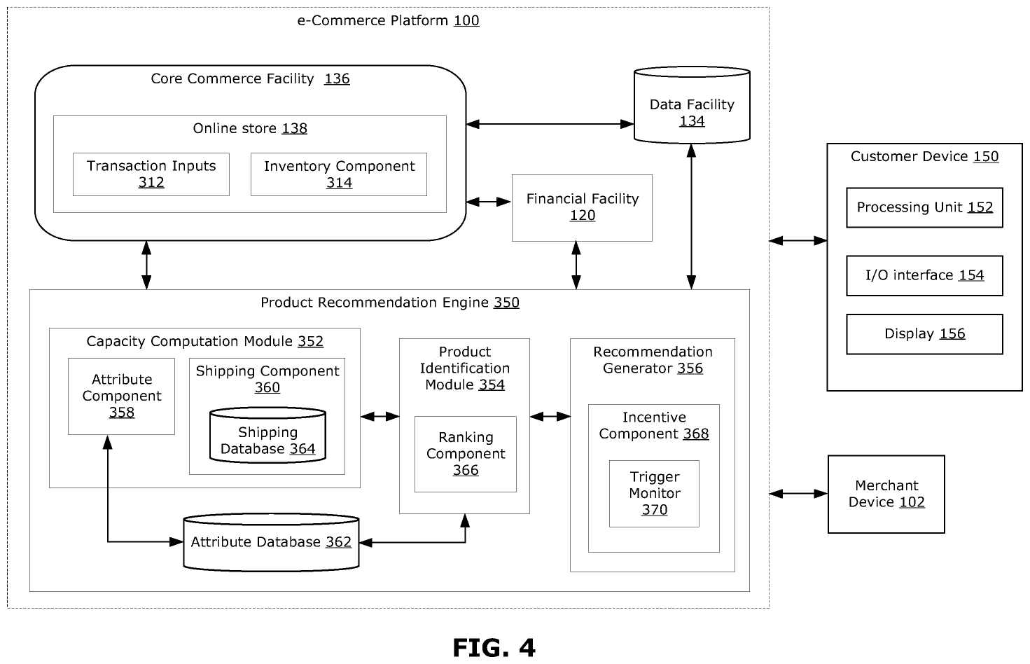

FIG. 4 is another depiction of the e-commerce platform 100 that omits some details that have been described with reference to FIG. 1, and shows further details discussed below. In particular, FIG. 4 illustrates some example details of the e-commerce platform 100 that are relevant to providing contextual product recommendations to a customer during a transaction process. Some details of the e-commerce platform 100 are not shown, to avoid clutter. FIG. 4 illustrates other computing systems interacting with the e-commerce platform 100, including a customer device 150.

The customer device 150 may be any electronic device capable of displaying a user interface. Examples of suitable electronic devices include mobile devices (e.g., smartphones, tablets, laptops, etc.), among others. Examples of the present disclosure may also be implemented in non-wearable devices and/or non-mobile devices, such as desktop computing devices, workstations, tracking systems, and other computing devices. Example components of the customer device 150 are now described, which are not intended to be limiting. It should be understood that there may be different implementations of the customer device 150.

The shown customer device 150 includes at least one processing unit 152, such as a processor, a microprocessor, an application-specific integrated circuit (ASIC), a field-programmable gate array (FPGA), a dedicated logic circuitry, a graphics processing unit (GPU), a central processing unit (CPU), a dedicated artificial intelligence processor unit, or combinations thereof.

The customer device 150 also includes at least one input/output (I/O) interface 154, which interfaces with input and output devices. In some examples, the same component may serve as both input and output device (e.g., a display 156 may be a touch-sensitive display). The customer device 150 may include other input devices (e.g., buttons, microphone, touchscreen, keyboard, etc.) and other output devices (e.g., speaker, vibration unit, etc.).

Returning to commerce platform 100, FIG. 4 illustrates the e-commerce platform 100 with a single instance of an online store 138 for simplicity. However, it should be understood that there may be multiple online stores 138 on the e-commerce platform 100, each with a checkout transaction process. The checkout transaction process of the online store 138 is associated with transaction inputs 312 and may be facilitated by financial facility 120. Customer-specific and purchase-specific information are included in the transaction inputs 312. For example, the customer-specific input may include a shipping address, and the purchase-specific input may include the total value of the customer's cart.

The online store 138 is also shown with an inventory component 314, which may be a software component. The inventory component 314 may record where products are stocked for the online store 138, and track quantities of those products.

After a customer has added one or more products offered at the online store 138 of a merchant to their cart, the customer may initiate the transaction process by proceeding to checkout. The product recommendation engine 350 may be initiated during the transaction process. In the depicted embodiment, the product recommendation engine 350 is in communication with, among other things, the core commerce facility 136, the financial facility 120, and the data facility 134. The product recommendation engine 350 is generally configured to generate contextual product recommendations during the transaction process, and in the present implementation, to generate contextual product recommendations taking into account shipping costs and limitations.

Shipping plays a significant role in the direct-to-consumer commerce ecosystem and can represent a major expense to a merchant. Typically, shipping is conducted by a third-party service provider for a fee. These shipping fees/rates are either paid by the merchant (e.g., marketed as “free” shipping to the customer) or passed on to the customer as a billed line item. If the shipping fees are passed on to the customer, they are often passed on as an estimate of the actual shipping cost (e.g., as a flat shipping cost, or as a per unit shipping cost).

The parcel shipping rates of third-party shipping providers are generally dependent on the total weight and/or dimensions of the parcel. A dimensional weight may be calculated by determining the volume of the parcel and assigning an estimated weight based on the volume. The shipping rate is then determined based on the dimensional weight or the actual weight, whichever is greater. Most of the time, the actual weight is greater and, thus, used to determine the shipping rate.

However, the relationship between the shipping rate and the weight/dimensions of the parcel may be non-linear. Third-party shipping providers often have a shipping hierarchy with multiple shipping tiers. Each shipping tier may be defined by a shipping rate (for example, a flat rate or cost/pound) and minimum and maximum thresholds. These attribute thresholds may be weight or dimension thresholds as they relate to a given parcel. The shipping rates and the attribute threshold of each shipping tier are assigned by the shipping provider and often reflect the cost of delivery and logistical limitations, while also simplifying the quote to the customer. Thus, while the relationship between the shipping rate and the weight/dimensions of any given parcel may be linearly correlated, it is often non-linear.

As noted above, when shopping at brick and mortar stores, a customer can physically interact with the product(s) and assess their size and weight etc. The customer also generally does not require the products to be shipped to their home, as they usually take the products with them. That is not the case in the realm of e-commerce. In e-commerce, customers and merchants are often unaware of the shipping provider's weight/dimension thresholds at each shipping tier, nor are they typically aware of how the corresponding shipping rates will change when the parcel crosses into another shipping tier. The inability to accurately assess the total volume and/or weight of a combination of products, and inability to optimize shipping capacity and costs in real time, are computer problems that are unique to e-commerce, as equivalent issues simply do not exist in traditional brick and mortar shopping methods.

This often leads to suboptimal use of the shipping provider's resources, for example shipping a heavy item in a box by itself when there is space to also include several lighter items for the same shipping cost (since the shipping cost will be largely driven by the weight of the heavy item). This can result in loss of potential additional sales for the merchant and can result in reduced value for the customer. Further, this suboptimal shipping may result in a waste of physical resources at the carrier, such as packaging, vehicle usage, fuel, personnel, etc., not to mention the environmental impact of such inefficiencies.

The present product recommendation engine 350 therefore addresses a unique online, electronic problem that has no non-computerized equivalent, and presents a solution that also uniquely requires an online, electronic implementation that has not non-computerized equivalent. The present disclosure provides the technical solution of a more intelligent recommendation engine that enables optimization of the available shipping capacity of a current transaction, by generating recommendations for products that can fit within available shipping capacity. In particular, the present product recommendation engine 350 takes the above shipping restrictions/concerns into account when generating contextual product recommendations during the transaction process. To that end, the product recommendation engine 350 comprises a capacity computation module 352, a product identification module 354, and a recommendation generator 356.

In the present embodiment, the capacity computation module 352 is configured to determine excess or remaining shipping capacity when shipping the one or more products. As such, the capacity computation module 352 comprises an attribute component 358 and a shipping component 360. The attribute component 358 is configured to compute a parcel attribute of an expected parcel that would be used to ship the one or more products. The parcel attribute of the expected parcel may be any measurable parameter of the expected parcel, including weight or a dimension of the expected parcel. The dimension may be one or more of the expected parcel's length, width, and height. The parcel attribute may also be a combination of the expected parcel's weight and dimension, sometimes referred to as dimensional weight or volumetric weight. The attribute component 358 is configured to compute the parcel attribute by estimating the collective weight and dimensions of the one or more products in the customer's cart at checkout.

The attribute component 358 may compute the parcel attribute by looking up the weight and size (or dimensions) of each of the products in the customer's cart from an attribute database 362, which stores metadata/metafields for each product in the merchant's online store 138. The attribute data of all of the merchant's products may have been previously inputted or automatically uploaded/updated by the merchant of the online store 138. To estimate the weight and/or dimensions of the expected parcel, the attribute component 358 may also consider other factors, including whether one or more of the products fit together or stack efficiently. For example, three baseball caps may be stacked together such that their combined shipping dimension (say length) is less than the simple summation of their individual lengths. To learn this, the attribute component 358 may keep a record of actual parcel dimensions and weights from previously fulfilled orders in the attribute database 362 and/or the data facility 134. Alternatively, the e-commerce platform 100 may be integrated with, or may be in direct communication with, a fulfillment network (not shown) (including a fulfillment manager module/server), which may store the records of actual parcel dimensions and weights from previously fulfilled orders across multiple merchants on the platform. This may enable the attribute component 358 to access historical data about actual shipping dimensions/weights and actual associated shipping costs of previously shipped parcels with similar products. In other cases, the merchant may simply provide the combined dimensions of two or more of the same item and the attribute component 358 may use that information to determine the overall parcel dimensions.

The shipping component 360 is configured to identify, based on the computed parcel attribute, an applicable shipping rate for delivering the expected parcel. To that end, the shipping component 360 uses the transaction inputs 312, such as shipping address and desired shipping speed provided by the customer (which may be provided at the time of checkout, or retrieved from memory if the customer has logged onto the e-commerce platform 100), to then determine which shipping method is best (such as cheapest) for the merchant to use to fulfill that order. Determining the relevant shipping method may be done in any known manner, including consulting a shipping database 364 and/or requesting shipping estimates through API calls to a third-party application associated with a shipping provider. In other cases, the relevant shipping method may be determined based on the customer's order history, where the shipping component 360 identifies which shipping method was, for example, most frequently selected for past orders. The selected shipping method would typically be associated with a shipping rate and an attribute (weight and/or dimensional) threshold.

Based on the estimated parcel attribute and selected shipping method for shipping the expected parcel, the capacity computation module 352 determines whether there is any available free or low cost shipping capacity available in the expected parcel. The available shipping capacity may be defined as the available (or permitted) increase in the parcel attribute that results in an increase in the shipping rate that does not exceed a defined shipping rate increase threshold. That is, the available shipping capacity (also referred to as an attribute increase threshold) is the amount by which the weight and/or dimension of the estimated parcel can be increased, without increasing the overall shipping rate of the parcel beyond a defined threshold amount. Increasing the weight or dimensions of the expected parcel (by adding one or more products to the parcel) typically corresponds with a change (usually an increase) in the shipping rate. The shipping rate increase threshold is the maximum predefined increase that the shipping rate may increase by, which may be preset by the merchant of the online store 138 or set as default by the e-commerce platform 100 for example. In the present embodiment, the shipping rate increase threshold is nominal (such as a small amount, $5) or nothing ($0). In some examples, the shipping rate increase threshold may vary depending on the current shipping rate of the estimated parcel (e.g., a percentage of the current shipping rate).

Thus, to compute the attribute increase threshold, the capacity computation module 352 first identifies the shipping rate increase threshold.

If the shipping rate increase threshold is $0 (i.e. no additional shipping fees are to be paid), the increase in the shipping rate must also be $0. The capacity computation module 352 then determines the attribute increase threshold that corresponds with this $0 increase in the shipping rate. The capacity computation module 352 may do this by comparing the estimated dimensions/weight (i.e. the parcel attribute) of the expected parcel with the selected shipping method's weight/dimensional (attribute) threshold.

In a first example (Example 1), if the shipping rate of the selected shipping method is the same for parcels up to a maximum of 2 pounds, and if the estimated parcel attribute of the expected parcel is 1.5 pounds, the attribute increase threshold is the difference between the maximum attribute of the current shipping rate and the current estimated parcel attribute, i.e. 0.5 pounds. The capacity computation module 352 would thus compute the attribute increase threshold (also referred to as the available shipping capacity) to be 0.5 pounds.

If the shipping rate increase threshold is nominal, such as $5 (i.e. no more than $5 of additional shipping fees are to be paid), the increase in the shipping rate may be up to $5. The capacity computation module 352 then determines the attribute increase threshold that corresponds with this up to $5 increase in the shipping rate.

In a second example (Example 2), the shipping rate of the selected shipping method is the same for parcels weighing up to a maximum of 2 pounds, the shipping rate increases by $3 for parcels weighing up to a maximum of 3 pounds, and the estimated parcel attribute of the expected parcel is 1.5 pounds. In such a case, if the parcel attribute increases up to 3 pounds, the increase in the shipping rate ($3) does not exceed the shipping rate increase threshold ($5), and such an increase in the parcel attribute is deemed acceptable. Thus, the attribute increase threshold is the difference between the maximum attribute corresponding to the shipping rate increase (3 pounds) and the parcel attribute of the expected parcel (1.5 pounds), the difference being 1.5 pounds.

However, if the shipping rate increases by $7 for parcels weighing up to a maximum of 3 pounds, the increase in the shipping rate ($7) exceeds the shipping rate increase threshold ($5), and such an increase is not acceptable. Thus, the attribute increase threshold is the difference between the maximum attribute corresponding to the shipping rate increase that does not exceed $5 (i.e. 2 pounds with $0 increase in shipping) and the parcel attribute of the expected parcel (1.5 pounds), the difference being 0.5 pounds.

After the capacity computation module 352 has determined the attribute increase threshold (also referred to as the available shipping capacity), the product identification module 354 is configured to identify one or more additional products, where each additional product has a corresponding attribute (i.e. weight or dimension). Notably, the corresponding attribute of the one or more additional products falls within the attribute increase threshold. The product identification module 354 may also be in communication with the attribute database 362 to search the online store's 138 inventory for products whose weight and/or dimensions fall within the attribute increase threshold.

Continuing with Example 1, the product identification module 354 may identify one or more of the products in the online store's 138 inventory which have a weight that is 0.5 pounds or less.

The product recommendation engine 350 further includes the recommendation generator 356, which is configured to generate at least one recommendation for at least one of the one or more additional products in real-time during the transaction process (e.g., one recommendation may be generated for each of the at least one recommended additional products). The recommendation generator 356 may provide the recommendation in a number of ways. For example, the recommendation may be provided on the display 156 of the customer device 150 as a selectable icon on the checkout page, showing text and/or an image of the corresponding identified additional product. The recommendation may be selectable (or may include a selectable link) that, when selected, causes the recommended product to be automatically added to the customer's cart.

Upon receiving selection of one of the recommendations, (e.g., provided via the I/O interface 154 of the customer device 150 communicating with the e-commerce platform 100), the product recommendation engine 350 is further configured to add the corresponding additional product to the customer's cart in the transaction process, and the financial facility 120 is then configured to complete the transaction process for the one or more products and the additional product.

Ranking Recommendations

If only one or a few (e.g., fewer than five) additional products are identified by the product identification module 354, then their subsequent recommendation may be relatively simple to understand by a customer. However, in some cases multiple or a great number (e.g., greater than 10) of additional products may be identified. In such a case, the product identification module 354 may have a ranking component 366 that is configured to categorize or rank the multiple identified additional products and select a subset of the ranked additional products to recommend. In other words, the ranking component 366 may be further configured to select which additional products should be presented as the recommended additional products, and to define the order in which the recommended additional products should be presented on the customer device 150.

The ranking component 366 may be configured to conduct this ranking/categorization based on a variety of different factors. For example, the additional products that are related to the one or more products in the customer's cart, such as based on a general correlation matrix (which may be maintained in the data facility 134 of the e-commerce platform 100), may be ranked higher than unrelated products. Alternatively, because related items are likely to already be included in the cart and/or in order to promote less commonly purchased products, the additional products that are less commonly purchased together may be ranked higher when recommended.

In another implementation, the ranking component 366 may be configured to rank the additional products based on their “staleness” and/or the lifespan of the additional product. The staleness of a product indicates how slowly the product has been selling (e.g., compared to typical selling rates of similar products in the same category, or compared to typical selling rates of other products belonging to the same online store). The staleness of the product may additionally or alternatively be based on the fact that the corresponding merchant simply has far too much inventory in stock. In such a case, the ranking component 366 may be in communication with the inventory component 314 of the online store 138 in order to access such data.

The lifespan of the product is an indication of the period of time in which the product is likely to be pertinent to most customers and is most likely to be purchased. An example of such a product is a seasonal item, whose relevance to most customers is generally limited to a certain time of year. In the case of “stale” additional products and/or additional products with a lifespan that is coming to an end, the ranking component 366 may be configured to rank these products higher than products which are less stale, relevant year-round, or have long lifespans.

After the additional products have been ranked, the ranking component 366 may be configured to select the first (i.e., highest ranked) or top subset (i.e., a number of the highest ranked) of the ranked additional products to be recommended. For example, if 100 additional products were identified by the product identification module 354, the ranking component 366 may rank the 100 additional products and select the highest ranked 10 additional products for recommendation by the recommendation generator 356.

The ranking component 366 may also have additional logic to lower the ranking of certain items that may not be relevant to the present purposes. For example, the ranking component 366 may lower the ranking of gift cards, or popular items that can be quickly sold without recommendations.

Incentives

To encourage the customer to add one or more of the recommendations or additional products to their cart, the recommendation(s) may be offered with an incentive, such as indicating “no additional shipping required”, or offered with a discounted price. In such a case, the recommendation generator 356 may have an incentive component 368 that is configured to identify the incentive and correlate the incentive with the recommendation of the corresponding additional product. The recommendation generator 356 is then configured to provide the recommendation(s) with the correlated incentive.

The customer may be generally unaware of the dimension or weight thresholds for any given shipping method. Customers are also unlikely to spend the time to determine what the various shipping parameters for different shipping methods are. Returning to Example 1, when the shipping rate increase threshold is $0, the incentive component 368 may identify the incentive to be the fact that selection of at least one of the selectable recommended products requires no additional shipping costs. Notification of such may be correlated with the corresponding additional product by the incentive component 368 and provided as the recommendation.

In other cases, the incentive may be a notification that shipping is free once their cart value exceeds a certain dollar amount (e.g., free shipping over $50). However, the actual shipping cost and parcel threshold remains hidden from the customer. Once the free shipping threshold is passed, no additional benefit is offered to the customer for adding more products to their cart.

As an additional or alternative incentive, the merchant may offer a discount on the identified additional products if they are added to the customer's cart. This indication may be inputted from the merchant device 102 to the incentive component 368. The incentive component 368 may then identify such an incentive and correlate it with its corresponding additional product and notification of such may be provided with/in the recommendation.

The incentive component 368 may identify or calculate the amount of discount offered using a variety of ways. The merchant may simply pre-set the amount of discount offered with the additional products, or pre-set a different discount to be offered with different products, providing such indication through the merchant device 102 to the incentive component 368.

Alternatively, the incentive component 368 may be configured to calculate the discount in real-time, taking a number of different factors into account. Some factors may include the staleness and/or lifespan of the additional product as described above. The merchant may indicate a maximum and/or minimum discount to the incentive component 368, and the incentive component 368 may be configured to determine the discount rate within that range.

Some of the different factors that the incentive component 368 may take into account to calculate a recommended discount include: original cost of the product to the merchant, quantity in storage, storage costs, profitability of each unit, sell-rate of the product, life-span of the product, hierarchy of shipping rates, and/or this or other customer's purchase history and price elasticity.

In cases where the storage costs for storing the additional product is high, and/or the sell-rate of the product is low, the incentive component 368 may recommend a higher discount for that item. In cases where the relevance or life-span of the recommended product is coming to an end, as described above, the incentive component 368 may also recommend a higher discount for that item. The opposite may be applied if the additional product has a high sell-rate, and/or if the recommended product is currently highly relevant to the customer. In such cases, the incentive component 368 may be configured to offer a lower discount, or no discount may be offered at all. In this way, the product recommendation engine 350 may enable more efficient use of warehousing resources (e.g., shelf space), and/or help to reduce merchant costs related to warehousing (e.g., storage costs).

In certain cases, the additional product may be so “stale”, or the cost of storing the product may be so high, that the incentive component 368 may be configured to offer the additional product for free to the customer at checkout as the incentive.

The incentive component 356 may also be configured to use the profitability or profit margin of a product to calculate the amount of discount that should be offered. If the profitability of the identified additional product is high, then a higher discount may be offered to encourage the sale. However, if the profitability of the additional product is low, then the profitability rate may be used as the maximum recommended discount that can be offered. For example, if an identified additional product has a profit margin of only 15%, offering a higher than 15% discount would put the merchant at a loss. As such, the incentive component 368 may be configured to set the maximum discount for this item at 15%, and notify or prevent the merchant from offering a discount of more than 15% for the particular item.

Incentive Trigger

In order to trigger the incentive or discount, the incentive component 368 may have a trigger monitor 370 that is configured to monitor the merchant's inventory levels and sell-rate of its products. In that regard, the trigger monitor 370 may also be in communication with the inventory component 314 of the online store 138. For example, if the trigger monitor 370 identifies “stale” inventory, such as by determining the product's sell-rate and predicting the amount of time that would be needed to clear the inventory, the trigger monitor 370 may be configured to send a notification to the corresponding merchant device 102, identifying the stale product, and optionally recommending that a discount on that product be offered to a customer at checkout. The trigger monitor 370 may also be configured to predict the life-span of a particular product and flag that item to be offered at a discount if that product is predicted not to sell out by the end of its lifespan. The trigger monitor 370 can also track a product to determine if it has reached a minimum sales threshold by a certain time. If not, the product can be flagged (for a discount). In this way, the product recommendation engine 350 may help to improve the management of a merchant's inventory, without requiring extensive manual operations. Further, the trigger monitor 370 may be configured to predict the life-span of a product by monitoring the selling of similar products (e.g., in the same product category) by other merchants associated with other online stores 138 on the e-commerce platform 100. This may enable the trigger monitor 370 to predict a product life-span based on real-time sales trends (e.g., if a previously popular product category has suddenly dropped in sales across a single or multiple online stores 138), to enable the produce recommendation engine 350 to recommend products more proactively in response to real-time changes in product life-span. It should be appreciated that such real-time insight derived from activity across multiple stores cannot be practically achieved using purely manual means.

As noted above, upon receiving selection of at least one of the recommendations (e.g., received by the e-commerce platform 100 via the I/O interface 154 of the customer device 150), the product recommendation engine 350 is further configured to add the corresponding additional product to the customer's cart in the transaction process, and the financial facility 120 is configured to complete the transaction process of the one or more products and the additional product.

However, prior to completing the transaction process, the product recommendation engine 350 and its components may, in some implementations, be configured to iteratively repeat their respective functions on the same cart during the transaction process. For example, after a recommended additional product is added to the customer's cart, the estimated parcel attribute is increased and thus the attribute increase threshold should decrease. This may result in one or more previously recommended additional products exceeding an updated attribute increase threshold and thus should no longer be recommended. In this way, it should be appreciated that the generated recommendations should be updated in real-time as the customer's cart is updated with additional product(s) during the transaction process. This process is discussed in further detail below.

Method

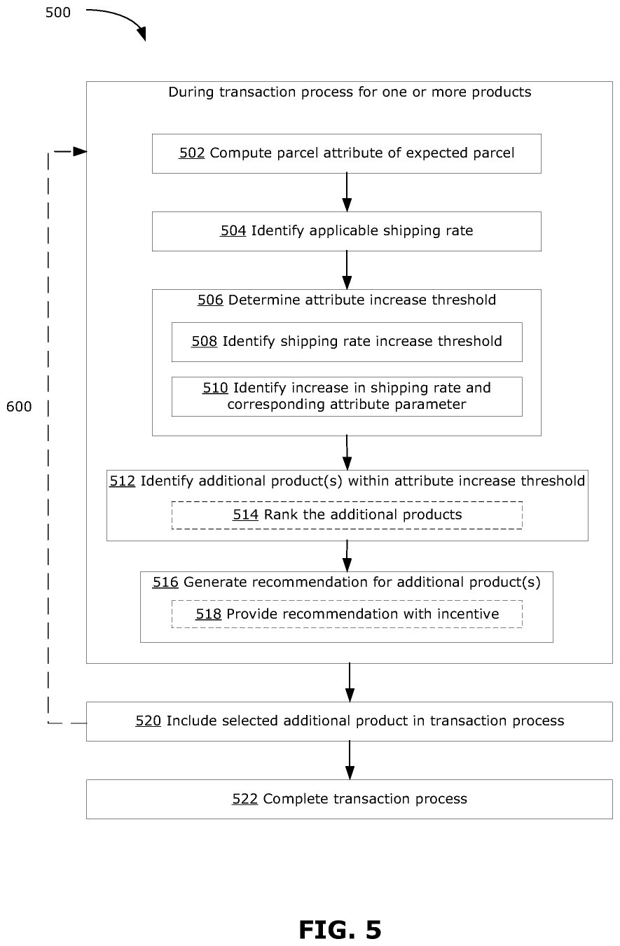

FIG. 5 is a flowchart illustrating an example method 500 for providing contextual product recommendations during a transaction process, where among other things, the recommendations take shipping rates into account. The example method 500 may be performed by the e-commerce platform 100 using the product recommendation engine 350, for example. In particular, the method 500 may be performed in real-time (or near real-time) during a transaction process with a given online store 138.

During a transaction process for one or more products offered at an online store 138 of a merchant, at an operation 502, a parcel attribute of an expected parcel for shipping the one or more products may be computed, where the parcel attribute is a weight and/or a dimension of the expected parcel. The parcel attribute may be computed by estimating the collective weight and dimensions of the one or more products in the customer's cart at checkout. The weight and size (or dimensions) of each of the products in the customer's cart may be looked up on a database storing such information. Historical data of parcel attributes of previously shipped parcels of similar products may alternatively be used to calculate the parcel attribute. In some cases, the attribute component 358 of the capacity computation module 352 may be used to perform operation 502.

At an operation 504, an applicable shipping rate for delivering the expected parcel may be identified based on the parcel attribute. Determining the applicable shipping method may be done in any known (or the usual) manner, including consulting a shipping database and/or requesting shipping estimates through API calls. The selected shipping method would typically be associated with a shipping rate and an attribute (weight and/or dimensional) threshold. In some cases, the shipping component 360 of the capacity computation module 352 may be used to perform operation 504.

Based on the parcel attribute and selected shipping method for shipping the expected parcel, at an operation 506, it is determined whether there is any available free or low cost shipping capacity available in the expected parcel. As noted above, the available shipping capacity may be defined as the available (or permitted) increase in the parcel attribute that results in an increase in the shipping rate that does not exceed a defined shipping rate increase threshold. That is, the available shipping capacity is the amount by which the weight and/or dimension of the estimated parcel can be increased, without increasing the overall shipping rate of the parcel beyond a defined threshold amount. The shipping rate increase threshold is the maximum predefined increase that the shipping rate may (acceptably) increase by, and may be identified at an operation 508. The shipping rate increase threshold may be preset by the merchant of the online store 138 or set as default by the e-commerce platform 100 for example. In the present embodiment, the shipping rate increase threshold may be nominal (such as a small amount, $5), nothing ($0), or a percentage of the current shipping rate.

Given this maximum increase that the shipping rate may (acceptably) increase by, the increase in shipping rate (up to but not exceeding the shipping rate increase threshold) can be identified at an operation 510, along with its corresponding attribute parameter. The difference between the corresponding attribute parameter and the parcel attribute of the expected parcel is/becomes the attribute increase threshold (also referred to as the excess/available shipping capacity).

At an operation 512, one or more additional products from the online store's 138 inventory is identified, where each additional product has a corresponding attribute (i.e. weight and/or dimension). The one or more additional products are identified at operation 512 because the corresponding attribute of each of the additional products falls within the attribute increase threshold (also referred to as the excess/available shipping capacity). In some cases, the product identification module 354 may be used to perform operation 512.

At an optional operation 514, if multiple additional products are identified at operation 512, the multiple additional products may be ranked and a subset of the ranked additional products may be selected for subsequent recommendation. The ranking may be performed based on a variety of different factors, including but not limited to a general correlation matrix relative to the one or more products in the customer's cart, “staleness” of the additional product, and the lifespan of the additional product. After the additional products have been ranked, the highest or top-ranked subset of the ranked additional products may be selected to be recommended. For example, if 100 additional products were identified and ranked, the top/highest-ranked 10 additional products may be selected for subsequent recommendation.

At an operation 516, at least one recommendation for at least one of the one or more additional products is generated in real-time during the transaction process. In the case where the additional products were ranked and the subset of the additional products were selected, recommendations for the additional products in the subset may be generated. In some implementations, the recommendation may be provided on the display 156 of the customer device 150 as a selectable icon or link on the checkout page, showing text and/or an image of the corresponding identified additional product. Operation 516 may be performed using the recommendation generator 356.

At an operation 518, optionally, the recommendation(s) may be provided with an incentive. In such a case, the incentive may be identified and correlated with the recommendation of its corresponding additional product. The incentive may be an indication that “no additional shipping required”, or the additional product may be offered with a discounted price.

If the incentive is a discount, the operation 518 may further include determining or calculating the amount of discount. The discount may simply be determined when the merchant inputs the discount offered with the additional products, or inputs a different discount to be offered with different products. Alternatively, the discount may be calculated in real-time, taking a number of different factors into account. Some factors may include the staleness of the additional product, the original cost of the product to the merchant, quantity in storage, storage costs, profitability of each unit, sell-rate of the product, life-span of the additional product, hierarchy of shipping rates, and/or the customer's purchase history and price elasticity.

At an operation 520, upon receiving selection of one of the recommendations, (e.g. provided via the I/O interface 154 of the customer device 150, communicating with the e-commerce platform 100), the corresponding additional product may be added to the customer's cart in the transaction process.

At an operation 522, the transaction process with the one or more products and the additional product may be completed.

Prior to completing the transaction process at operation 522, in some implementations, operations 502 to 518 may be repeated (iteratively) on the same cart during the transaction process. This may be beneficial if further shipping capacity is still available in the expected parcel after the additional product is added. The method can be applied until no meaningful amount of excess shipping capacity is left (e.g., the attribute increase threshold is less than 0.5 pound), or after a predefined number of iterations has been performed (e.g., three iterations).

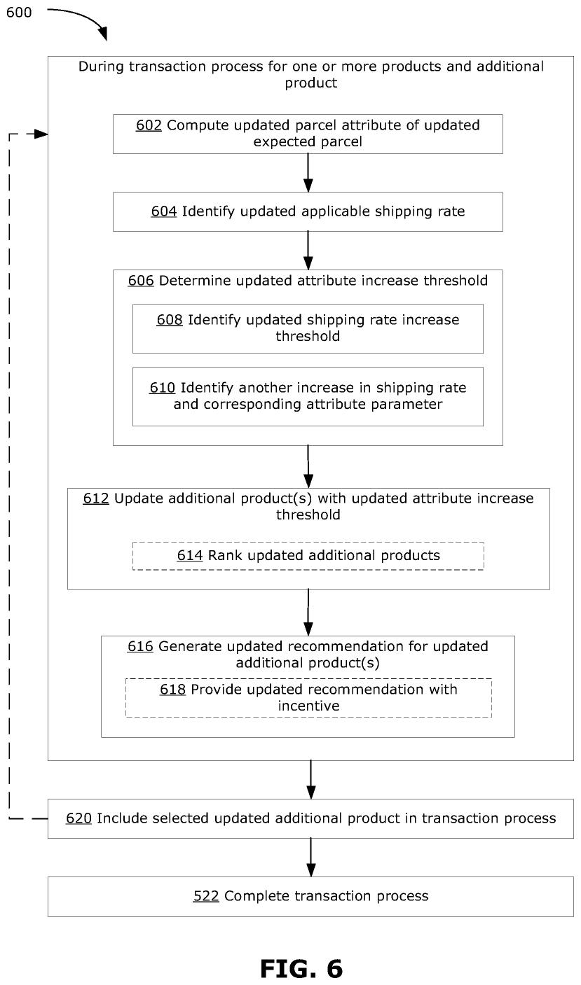

FIG. 6 is a flowchart illustrating an example method 600 that may be performed as a second iteration of operations 502 to 518.

At an operation 602, an updated parcel attribute of an updated expected parcel may be computed for shipping the one or more products and the additional product as added above. In some cases, the attribute component 358 of the capacity computation module 352 may be used to perform operation 602.

At an operation 604, based on the updated parcel attribute, an updated applicable shipping rate may be identified for delivering the updated expected parcel. In some cases, the shipping component 360 of the capacity computation module 352 may be used to perform operation 604.

At an operation 606, it is determined whether there is any updated available free or low cost shipping capacity available in the updated expected parcel. The updated available shipping capacity (also referred to as an updated attribute increase threshold) may be defined as the available (or permitted) increase in the updated parcel attribute that results in an updated increase in the shipping rate that does not exceed an updated shipping rate increase threshold. That is, the updated available shipping capacity is the amount by which the weight and/or dimension of the updated expected parcel can be increased, without increasing the overall shipping rate of the parcel beyond the updated defined threshold amount. Similar to the above, the updated shipping rate increase threshold is the maximum predefined increase that the updated shipping rate may (acceptably) increase by, and may be identified at an operation 608. To that end, the updated shipping rate increase threshold may be the same value as the shipping rate increase threshold identified at the operation 508. Alternatively, the updated shipping rate increase threshold may be a different value from the shipping rate increase threshold. It may be preset by the merchant of the online store 138 or set as default by the e-commerce platform 100. Similar to the above, the updated shipping rate increase threshold may be nominal (such as a small amount, $5), nothing ($0), or a percentage of the current shipping rate.

Given this maximum increase that the shipping rate may (acceptably) increase by, another increase in the shipping rate (up to but not exceeding the updated shipping rate increase threshold) can be identified at an operation 610, along with its corresponding attribute parameter. The difference between the corresponding attribute parameter and the updated parcel attribute of the updated expected parcel is/becomes the updated attribute increase threshold (also referred to as the updated excess/available shipping capacity).

At an operation 612, the additional products from the online store's 138 inventory, identified at the operation 512, may be updated, where the corresponding attribute of each of the updated additional products falls within the updated attribute increase threshold (also referred to as the updated excess/available shipping capacity). In some cases, the product identification module 354 may be used to perform operation 612. At an operation 614, the updated additional products may be ranked and a subset of the ranked updated additional products may be selected for subsequent recommendation.

At an operation 616, an updated recommendation for at least one of the one or more updated additional products may be generated in real time during the transaction process. Operation 616 may be performed using the recommendation generator 356. At an operation 618, the updated recommendation for the at least one of the one or more updated additional products may be provided with an incentive as described above.

At operation 620, responsive to receiving a selection of one of the updated recommendations, include the corresponding updated additional product in the transaction process, along with the one or more products and the additional product.

Prior to completing the transaction process at operation 522, in some implementations, as noted above, operations 502/602 to 518/618 (respectively) may be repeated (iteratively) on the same cart during the transaction process. The methods 500/600 can be applied until no meaningful amount of excess shipping capacity is left (e.g., the attribute increase threshold is less than 0.5 pound), or after a predefined number of iterations has been performed (e.g., three iterations).

The process can then return to operation 522 where the transaction process is completed with the one or more products, the additional product, the updated additional product, and subsequently added products (if any).

The above steps may be performed in real-time, where the additional and further products, their ranking, and their respective discount (if any) are dynamically determined in response to the items in the customer's cart at checkout, and in response to the shipping method selected to fulfill the order. Thus, if the items in the customer's cart change, or the shipping rate or shipping provider changes, the additional and further items, their ranking, and any associated discounts, may also change in real-time at checkout.

In certain applications, the e-commerce platform 100 may use the methods 500 and 600, and the product recommendation engine 350, to enable a merchant to offer free samples to the customer without incurring additional shipping costs.

Traditionally, if a merchant wishes to include a free gift or sample in a parcel for a particular order, the merchant usually does not consider whether the weight or dimensions of the free (or discounted) product causes the overall parcel weight/dimensions to exceed the current shipping parcel attribute threshold(s). In that case, the merchant may unknowingly incur additional shipping fees. To avoid this, merchants may refrain from offering free items, or only offer small and light items. To help alleviate this, the methods 500/600 and the product recommendation engine 350 are configured to identify only those products with attributes that cause the resulting expected parcel to fall within the available excess shipping capacity. In that manner, only those orders with sufficient additional or marginal shipping capacity would be offered the particular free (or discounted) item, as its inclusion would not (or only marginally) increase the shipping rate.

The use of the methods 500 and 600, and the product recommendation engine 350 provide the technical solution of a more intelligent recommendation engine that enables optimization of the available shipping capacity of a current transaction, by generating recommendations for products that can fit within available shipping capacity. They conveniently provide the customer with recommended additional/further items that come with an incentive, to encourage a customer to add the additional item(s) to their cart and thus result in a more resource-efficient shipment. The technical advantages of providing recommendations that take into account shipping costs include improved merchant sales, improved customer experience, more efficient management of inventory (including more efficient use of warehousing resources), more efficient usage of shipping resources and/or reduced environmental impact.

In e-commerce, the inability to accurately assess the total volume and/or weight of a combination of products, and inability to optimize shipping capacity and costs in real time, are computer problems that are unique to e-commerce, as equivalent issues simply do not exist in traditional brick and mortar shopping methods. The present disclosure addresses a unique online, electronic problem that has no non-computerized equivalent, and presents a solution that also uniquely requires an online, electronic implementation that has not non-computerized equivalent.

Although the present disclosure describes methods and processes with operations (e.g., steps) in a certain order, one or more operations of the methods and processes may be omitted or altered as appropriate. One or more operations may take place in an order other than that in which they are described, as appropriate.

Although the present disclosure is described, at least in part, in terms of methods, a person of ordinary skill in the art will understand that the present disclosure is also directed to the various components for performing at least some of the aspects and features of the described methods, be it by way of hardware components, software or any combination of the two. Accordingly, the technical solution of the present disclosure may be embodied in the form of a software product. A suitable software product may be stored in a pre-recorded storage device or other similar non-volatile or non-transitory computer readable medium, including DVDs, CD-ROMs, USB flash disk, a removable hard disk, or other storage media, for example. The software product includes instructions tangibly stored thereon that enable a processing device (e.g., a personal computer, a server, or a network device) to execute examples of the methods disclosed herein.

The present disclosure may be embodied in other specific forms without departing from the subject matter of the claims. The described example embodiments are to be considered in all respects as being only illustrative and not restrictive. Selected features from one or more of the above-described embodiments may be combined to create alternative embodiments not explicitly described, features suitable for such combinations being understood within the scope of this disclosure.

All values and sub-ranges within disclosed ranges are also disclosed. Also, although the systems, devices and processes disclosed and shown herein may comprise a specific number of elements/components, the systems, devices and assemblies could be modified to include additional or fewer of such elements/components. For example, although any of the elements/components disclosed may be referenced as being singular, the embodiments disclosed herein could be modified to include a plurality of such elements/components. The subject matter described herein intends to cover and embrace all suitable changes in technology.

1. A system comprising:
at least one processing unit and at least one memory, the at least one memory storing instructions executable by the at least one processing unit to cause the system to:
during a transaction process for one or more products offered at an online store of a merchant:
compute a parcel attribute of an expected parcel for shipping the one or more products, the parcel attribute being a weight or a dimension of the expected parcel;
identify, based on the parcel attribute, an applicable shipping rate for delivering the expected parcel;
determine an attribute increase threshold that corresponds to an increase in the shipping rate that is within a shipping rate increase threshold;
identify one or more additional products where each of the one or more additional products has a corresponding attribute that is within the attribute increase threshold; and
generate at least one recommendation for at least one of the one or more additional products in real-time during the transaction process;
responsive to receiving selection of one of the at least one recommendation, include the corresponding additional product in the transaction process; and
complete the transaction process.

2. The system of claim 1, the processing unit being further configured to execute instructions to cause the system to, after selection of the recommendation, and prior to completing the transaction process:
compute an updated parcel attribute of an updated expected parcel for shipping the one or more products and the additional product;
identify, based on the updated parcel attribute, an updated applicable shipping rate for delivering the updated expected parcel;
determine an updated attribute increase threshold that corresponds to an updated increase in the shipping rate that does not exceed an updated shipping rate increase threshold;
update the one or more additional products by identifying one or more updated additional products each having a corresponding attribute within the updated attribute increase threshold;
generate at least one updated recommendation for at least one of the one or more updated additional products in real time during the transaction process;
responsive to receiving selection of one of the at least one updated recommendation, include the corresponding updated additional product in the transaction process.

3. The system of claim 1, wherein the one or more additional products comprises multiple additional products, the processing unit being further configured to execute instructions to cause the system to:
rank the multiple additional products and select a subset of the ranked additional products, and the processing unit being further configured to execute instructions to cause the system to generate the recommendation for each of the ranked additional products in the subset in real-time during the transaction process.

4. The system of claim 3, the processing unit being further configured to execute instructions to cause the system to rank the additional products by sorting the additional products by correlation with the one or more products.

5. The system of claim 3, the processing unit being further configured to execute instructions to cause the system to rank the additional products by sorting the additional products by their staleness.

6. The system of claim 3, the processing unit being further configured to execute instructions to cause the system to rank the additional products by sorting the additional products by an amount of time in which the additional product is considered to be pertinent to the customer.

7. The system of claim 1, the processing unit being further configured to execute instructions to cause the system to provide the recommendation for the at least one of the one or more additional products as selectable recommended products, at least one of the selectable recommended products being provided with an incentive.

8. The system of claim 7, wherein the shipping rate increase threshold is zero, and wherein the incentive is a notification that selection of the at least one of the selectable recommended products requires no additional shipping costs.

9. The system of claim 7, wherein the incentive is a discount on one or more of the selectable recommended products.

10. The system of claim 1, the processing unit being further configured to execute instructions to cause the system to compute the parcel attribute of the expected parcel by using historical data of parcel attributes of previously shipped parcels of similar products.

11. A computer-implemented method comprising:
during a transaction process for one or more products offered at an online store of a merchant:
computing a parcel attribute of an expected parcel for shipping the one or more products, the parcel attribute being a weight or a dimension of the expected parcel;
identifying, based on the parcel attribute, an applicable shipping rate for delivering the expected parcel;
determining an attribute increase threshold that corresponds to an increase in the shipping rate that is within a shipping rate increase threshold;
identifying one or more additional products where each of the one or more additional products has a corresponding attribute that is within the attribute increase threshold; and
generating at least one recommendation for at least one of the one or more additional products in real-time during the transaction process;
responsive to receiving selection of one of the at least one recommendation, including the corresponding additional product in the transaction process; and
completing the transaction process.

12. The method of claim 11, following selection of the recommendation, and prior to completing the transaction process, the method further comprising:
computing an updated parcel attribute of an updated expected parcel for shipping the one or more products and the additional product;
identifying, based on the updated parcel attribute, an updated applicable shipping rate for delivering the updated expected parcel;
determining an updated attribute increase threshold that corresponds to an updated increase in the shipping rate that is within an updated shipping rate increase threshold;
updating the one or more additional products by identifying one or more updated additional products each having a corresponding attribute within the updated attribute increase threshold;
generating at least one updated recommendation for at least one of the one or more updated additional products in real time during the transaction process;
responsive to receiving selection of one of the at least one updated recommendation, including the corresponding updated additional product in the transaction process.

13. The method of claim 11, wherein the one or more additional products comprises multiple additional products, the method further comprising ranking the multiple additional products and selecting a subset of the ranked additional products, wherein the generating comprises generating the recommendation for each of the ranked additional products in the subset in real-time during the transaction process.

14. The method of claim 13, wherein ranking the additional products comprises sorting the additional products by correlation with the one or more products.

15. The method of claim 13, wherein ranking the additional products comprises sorting the additional products by their staleness.

16. The method of claim 13, wherein ranking the additional products comprises sorting the additional products by an amount of time in which the additional product is considered to be pertinent to the customer.

17. The method of claim 11, further comprising providing the recommendation for the at least one of the one or more additional products as selectable recommended products, at least one of the selectable recommended products being provided with an incentive.

18. The method of claim 17, wherein the shipping rate increase threshold is zero, and wherein the incentive is a notification that selection of the at least one of the selectable recommended products requires no additional shipping costs.

19. The method of claim 17, wherein the incentive is a discount on one or more of the selectable recommended products.

20. The method of claim 11, wherein computing the parcel attribute of the expected parcel is performed using historical data of parcel attributes of previously shipped parcels of similar products.

21. A computer readable medium having instructions encoded thereon, wherein the instructions, when executed by a computing system, cause the computing system to:
during a transaction process for one or more products offered at an online store of a merchant:
compute a parcel attribute of an expected parcel for shipping the one or more products, the parcel attribute being a weight or a dimension of the expected parcel;
identify, based on the parcel attribute, an applicable shipping rate for delivering the expected parcel;
determine an attribute increase threshold that corresponds to an increase in the shipping rate that is within a shipping rate increase threshold;
identify one or more additional products where each of the one or more additional products has a corresponding attribute that is within the attribute increase threshold; and
generate at least one recommendation for at least one of the one or more additional products in real-time during the transaction process;
responsive to receiving selection of one of the at least one recommendation, include the corresponding additional product in the transaction process; and
complete the transaction process.
